(19) United States
(12) Patent Application Publication
(10) Pub. No.: US 2023/0406129 A1
(43) Pub. Date: Dec. 21, 2023

(54) SYSTEM, METHOD, AND STORAGE MEDIUM FOR MANAGING UNMANNED AUTONOMOUS VEHICLE

(71) Applicant: TOYOTA JIDOSHA KABUSHIKI KAISHA, Toyota-shi (JP)

(72) Inventors: Shun OTA, Susono-shi (JP); Taro HASEGAWA, Toyota-shi (JP); Tomoya TAKEDA, Toyota-shi (JP); Yuka NISHIYAMA, Toyota-shi (JP); Hiroya CHIBA, Fuji-shi (JP); Tatsuya SUGANO, Sunto-gun (JP); Taizo MASUDA, Yokohama-shi (JP)

(73) Assignee: TOYOTA JIDOSHA KABUSHIKI KAISHA, Toyota-shi (JP)

(21) Appl. No.: 18/190,232

(22) Filed: Mar. 27, 2023

(30) Foreign Application Priority Data
Jun. 21, 2022 (JP) 2022-099707

(51) Int. Cl. B60L 53/36; B60L 53/66; B60L 53/30

(52) U.S. Cl. CPC B60L 53/36; B60L 53/66; B60L 53/305

(57) ABSTRACT

A system is configured to, if an unmanned autonomous vehicle that runs on electric power, for example, a robotaxi, needs to be charged, make a request of a person around a charging station, for example, a driver of an electrified vehicle being charged, to do work for charging the robotaxi with a smartphone. At this time, the system may make a request to do work for charging the robotaxi in return for giving an incentive.

### CROSS-REFERENCE TO RELATED APPLICATION

This application claims priority to Japanese Patent Application No. 2022-099707 filed on Jun. 21, 2022, incorporated herein by reference in its entirety.

### BACKGROUND

### 1. Technical Field

The disclosure relates to a system, a method, and a storage medium for managing an unmanned autonomous vehicle, such as a robotaxi, and, more specifically, to a system, a method, and a storage medium for managing the charging of an unmanned autonomous vehicle that runs on electric power.

### 2. Description of Related Art

When an unmanned autonomous vehicle that runs on electric power works as a robotaxi, the unmanned autonomous vehicle needs to be charged at some timing. However, as described in Japanese Unexamined Patent Application Publication No. 10-144357 (JP 10-144357 A), general charging stations need to connect a connector to a vehicle and disconnect the connector from the vehicle. For an unmanned autonomous vehicle with no driver, the unmanned autonomous vehicle is desirably charged fully automatically. However, it is not easy to fully automatically connect and disconnect the connector. If a battery runs out, not only an unmanned autonomous vehicle cannot work as a robotaxi but also the unmanned autonomous vehicle is difficult to return to an owner.

### SUMMARY

The disclosure is made in light of the above-described challenge. The disclosure allows an unmanned autonomous vehicle with no driver to operate without battery running out.

A first aspect of the disclosure provides a system. The system includes one or more processors, and a memory coupled to the one or more processors and storing a plurality of instructions that are executable. The plurality of instructions is configured to cause the one or more processors to, if an unmanned autonomous vehicle that runs on electric power needs to be charged, make a request of a person around a charging station to do work for charging the unmanned autonomous vehicle with an HMI.

A second aspect of the disclosure provides a method. The method is a method for managing, with a computer, an unmanned autonomous vehicle that runs on electric power. The method includes, if the unmanned autonomous vehicle needs to be charged, making a request of a person around a charging station to do work for charging the unmanned autonomous vehicle with an HMI.

A third aspect of the disclosure provides a storage medium for storing a program. The program is configured to, if an unmanned autonomous vehicle that runs on electric power needs to be charged, cause a computer to make a request of a person around a charging station to do work for charging the unmanned autonomous vehicle with an HMI. The program may be stored in a computer-readable recording medium.

With the system, the method, and the storage medium according to the aspects of the disclosure, an unmanned autonomous vehicle is allowed to operate without battery running out with the help of a person to charge the unmanned autonomous vehicle. There is an advantage to, if a person helps charge an unmanned autonomous vehicle, fully automatic connection and disconnection of a connector, which is technically difficult, does not need to be performed.

In the system, the method, and the storage medium according to the aspects of the disclosure, making a request to do work for charging the unmanned autonomous vehicle may include making a request of a user using the charging station to do work for charging the unmanned autonomous vehicle. A user using a charging station is regarded as the most familiar person to an unmanned autonomous vehicle and a person who is likely to help charge the unmanned autonomous vehicle.

In the system, the method, and the storage medium according to the aspects of the disclosure, making a request to do work for charging the unmanned autonomous vehicle may be performed in response to detection that the unmanned autonomous vehicle is on standby at the charging station. A person who has received a request to do work for charging just needs to do work for charging the unmanned autonomous vehicle being already on standby, so it is possible to easily help for an unmanned autonomous vehicle. The unmanned autonomous vehicle more easily gets the help from a person around the charging station.

In the system, the method, and the storage medium according to the aspects of the disclosure, if the unmanned autonomous vehicle needs to be charged, the unmanned autonomous vehicle may be headed for the charging station being used by a user. When a user is using the charging station, there is an increased likelihood that someone gives help to the unmanned autonomous vehicle. When there is a plurality of charging stations being used by users, a charging station being used by a larger amount of users may be selected.

In the system, the method, and the storage medium according to the aspects of the disclosure, the HMI used to make a request to do work for charging may be a mobile terminal that a person around the charging station carries or a vehicle mount terminal of a vehicle in which a person around the charging station is riding. More specifically, the system, the method, and the storage medium according to the aspects of the disclosure may be configured to make a request of a person who has installed an application in a mobile terminal or a vehicle mount terminal to do work for charging via the application. By directly providing notification via the application about work for charging, a person who receives the notification is encouraged to get a higher sense of ownership on the unmanned autonomous vehicle. Thus, there is an increased likelihood that someone helps do work for charging. The HMI used to make a request to do work for charging may be an external HMI mounted on the unmanned autonomous vehicle.

In the system, the method, and the storage medium according to the aspects of the disclosure, making a request to do work for charging the unmanned autonomous vehicle may include making a request o do work for charging the unmanned autonomous vehicle in return for giving an incentive. Giving an incentive increases the likelihood that someone helps do work for charging. When the application is installed in a mobile terminal or a vehicle mount terminal, giving an incentive may be performed by using the application.

As described above, with the system, the method, and the storage medium according to the aspects of the disclosure, an unmanned autonomous vehicle without a driver is operated without battery running out with the help of a person around a charging station to charge the unmanned autonomous vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that shows the configuration of a management system for an unmanned autonomous vehicle (robotaxi) according to an embodiment of the disclosure;

FIG. 2 is a diagram that illustrates instructions to designate a charging station for the robotaxi by a vehicle management server;

FIG. 3 is a diagram that shows an example of a screen of a smartphone displaying the statuses of neighborhood charging stations for a potential participant;

FIG. 4 is a flowchart that shows the flow of a process of making a request of a potential participant from a charging station management server; and

FIG. 5 is a diagram that shows an example of a screen of a smartphone used to make a request of a potential participant to help charge a robotaxi.

### DETAILED DESCRIPTION OF EMBODIMENTS

Hereinafter, a system for managing an unmanned autonomous vehicle, a method that is executed in the management system, and a program for causing a computer to execute the method according to an embodiment of the disclosure will be described with reference to the accompanying drawings. Hereinafter, the system for managing the unmanned autonomous vehicle is referred to as management system, and the method that is executed in the management system is referred to as management method. The program for causing a computer to execute the management method is referred to as management program.

In the specification, the unmanned autonomous vehicle means an autonomous vehicle in which no one who is able to do work for maintaining the operation of the vehicle, such as a driver, is riding. However, the unmanned autonomous vehicle does not necessarily mean a constantly unmanned vehicle. When, for example, an autonomous vehicle that a person owns and usually rides as a driver is used as an unmanned taxi without any schedule of use by the person, the autonomous vehicle becomes an unmanned autonomous vehicle. An autonomous vehicle that is used as an unmanned taxi is generally called a robotaxi. In the present embodiment, the unmanned autonomous vehicle to be managed by the management system is a robotaxi.

The autonomous vehicle serving as a robotaxi includes an autonomous driving system capable of autonomous driving higher than or equal to Level 4 defined in Society of Automotive Engineers (SAE). The autonomous driving system includes a camera that recognizes a situation around a vehicle, an external sensor, such as LiDAR, a vehicle status sensor that detects a vehicle status, such as an acceleration and a yaw rate, and one or more ECUs that generate a target trajectory of the vehicle by processing information from those sensors. The configuration and functions of the autonomous driving system are known, and the known ones may be applied to the autonomous vehicle, so the description of the details of the autonomous driving system is omitted.

In the specification, the robotaxi is an electrified vehicle that has a rechargeable battery and that runs on electric power stored in a battery, such as a battery electric vehicle (BEV) and a plug-in hybrid electric vehicle (PHEV). Therefore, work for maintaining operation, described in the specification, is typically work for charging an electrified vehicle, and is specifically work for connecting a connector of a charger to the electrified vehicle and work for removing the connector from the electrified vehicle.

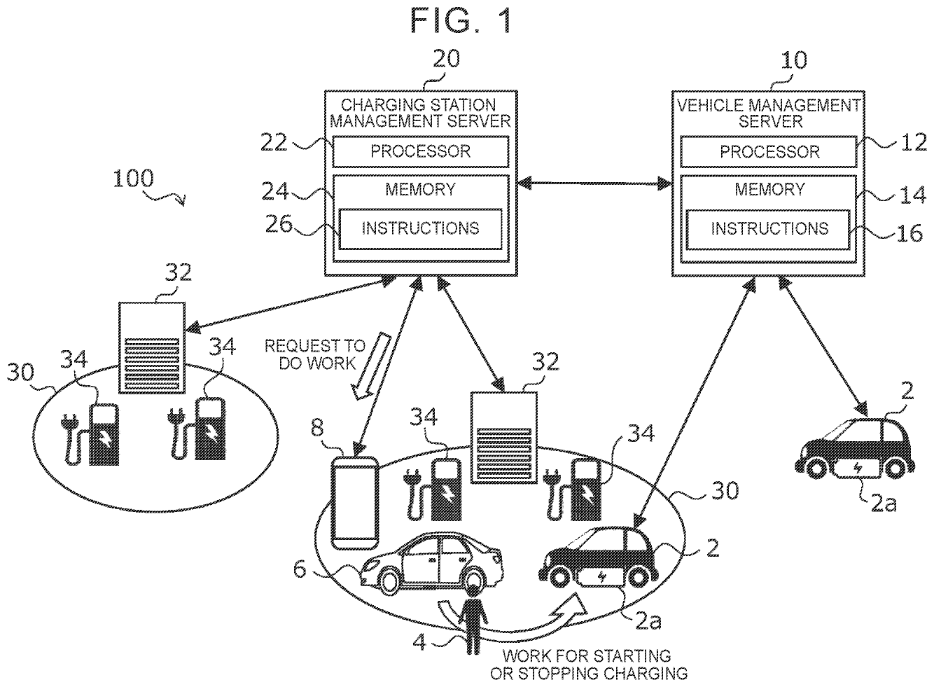

The configuration of the management system according to the present embodiment is shown in FIG. 1. As shown in FIG. 1, the management system 100 includes a vehicle management server 10 and a charging station management server 20. The vehicle management server 10 and the charging station management server 20 are connected by a network. Alternatively, the vehicle management server 10 and the charging station management server 20 may be integrated into a single server. Each of the vehicle management server 10 and the charging station management server 20 may be made up of a plurality of servers connected by a network.

The vehicle management server 10 is a server that manages the operations of robotaxis 2. The vehicle management server 10 manages the operations of the plurality of robotaxis 2 that provide service in a predetermined area. The vehicle management server 10 includes a processor 12 and a program memory 14. The processor 12 is communicably coupled to the program memory 14. The program memory 14 is a non-transitory storage medium that stores a plurality of instructions 16 that are executable. When the processor 12 executes at least some of the instructions 16, the following functions are implemented by the vehicle management server 10.

The functions to be implemented by the vehicle management server 10 include services needed to manage the robotaxis 2, such as receiving reservations from taxi users, dispatching robotaxis 2 to taxi users, generating travel routes of robotaxis 2 to destinations, and identifying the current locations of robotaxis 2. The vehicle management server 10 has a function to manage the state of charge of a battery 2a of each robotaxi 2. With the management function, the vehicle management server 10 acquires information on the state of charge of the battery 2a (SOC information) from each robotaxi 2 at certain time intervals. The vehicle management server 10 provides instructions to the robotaxi 2, of which the SOC lower than or equal to a threshold has been detected, to go to a charging station 30.

The charging station management server 20 is a server that manages the charging station 30. The charging station 30 is a station provided in a city to charge electrified vehicles. One or more chargers 34 are installed in the charging station 30. The charger 34 is a manually operated charger that requires a person to connect a connector to an electrified vehicle at the start of charging and to disconnect the connector from the electrified vehicle at the end of charging. Alternatively, different from the manually operated charger 34, a full-automatic charger that does not require help from a person, such as a noncontact charger, may be installed in the charging station 30.

The charging station management server 20 manages the one or more charging stations 30. The charging station management server 20 includes a processor 22 and a program memory 24. The processor 22 is communicably coupled to the program memory 24. The program memory 24 is a non-transitory storage medium that stores a plurality of instructions 26 that are executable. When the processor 22 executes at least some of the instructions 26, the following functions are implemented by the charging station management server 20. The instructions 26 stored in the program memory 24 make up at least part of a management program together with the instructions 16 stored in the program memory 14 of the vehicle management server 10.

The functions to be implemented by the charging station management server 20 include communication with the charging station management server 20, communication with a communication terminal 32 installed in the charging station 30, and communication with a mobile terminal that a person 4 around the charging station 30 carries. The communication terminal 32 is an instrument that transmits, to the charging station management server 20, information on the statuses of vacancy of the chargers 34 and information on vehicles respectively connected to the chargers 34. The charging station management server 20 and the communication terminal 32 are connected by the Internet or a private line. The person 4 around the charging station 30 is a user of the charging station 30 and is also a driver of an electrified vehicle 6 to be charged at the charging station 30. The mobile terminal is typically a smartphone 8. Communication between the charging station management server 20 and the smartphone 8 is performed by the application installed in the smartphone 8.

Each of the chargers 34 installed in the charging station 30 is a charger that requires involvement of a person to connect and disconnect the connector. Therefore, the robotaxi 2 without a driver is regarded as being unsuitable for use at the charging station 30. However, there are not so many charging stations in which a full-automatic charger is installed. For this reason, the management system 100 makes it possible to use a charging station in which no full-automatic charger is installed, by making a request of a potential participant around the charging station 30 to do work for charging the robotaxi 2.

The potential participant is the person 4 around the charging station 30 and is typically a user of the charging station 30, that is, a driver of the electrified vehicle 6 being charged at the charging station 30. The charging station management server 20 determines a potential participant based on the current location of the robotaxi 2, identified by a GPS. For example, the charging station management server 20 determines a person in a predetermined area including the current location of the robotaxi 2 as a potential participant. When the charging station management server 20 seeks the help to do work for charging the robotaxi 2, the charging station management server 20 transmits a request to do work to the smartphone 8 of the potential participant.

Hereinafter, a series of processes in the management system 100 from when the robotaxi 2 needs to be charged to when the robotaxi 2 is charged will be described.

The vehicle management server 10 determines whether the robotaxi 2 needs to be charged, based on SOC information transmitted from the robotaxi 2 to the vehicle management server 10. In response to a decrease in the SOC of the battery 2a to the threshold or below, the vehicle management server 10 determines that charging is needed. The vehicle management server 10 provides instructions to the robotaxi 2 that needs to be charged, to enter the charging station 30.

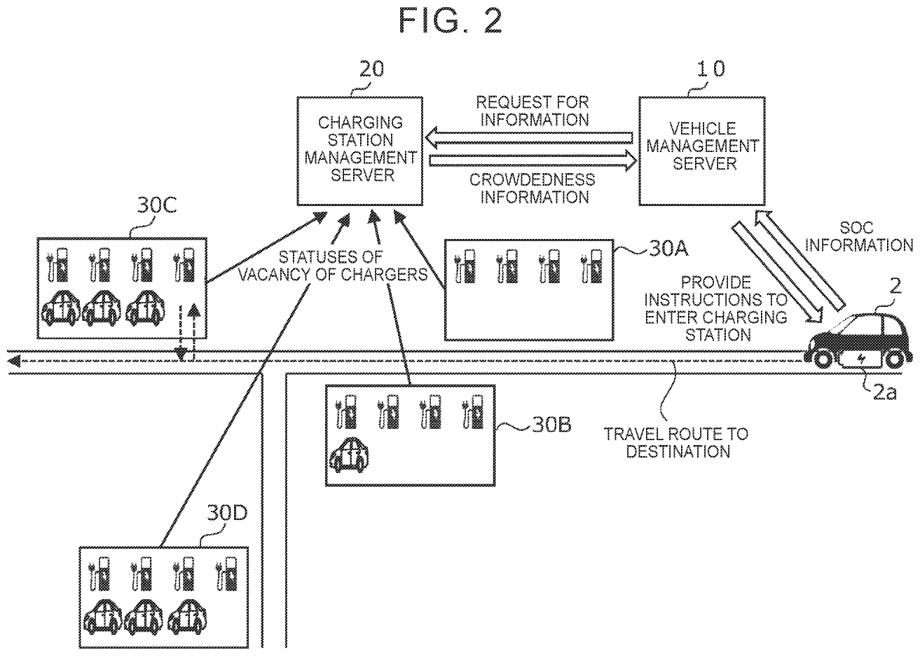

FIG. 2 is a diagram that illustrates instructions to designate the charging station 30 for the robotaxi 2 by the vehicle management server 10. When the robotaxi 2 needs to be charged, the vehicle management server 10 searches for the charging station 30 based on map information. The charging station 30 to be searched for is a charging station within a range of a certain distance from a travel route to a destination of the robotaxi 2. In the example shown in FIG. 2, there are four charging stations 30A, 30B, 30C, 30D near the travel route to the destination. The vehicle management server 10 demands information on the charging stations 30A, 30B, 30C, 30D from the charging station management server 20.

The charging station management server 20 provides the vehicle management server 10 with information on the degree of crowdedness (crowdedness information) of each of the charging stations 30A, 30B, 30C, 30D in response to the demand from the vehicle management server 10. Examples of the pieces of crowdedness information) include information on the usage rate of each charger, information on the number of electrified vehicles being charged, and information on the number of electrified vehicles waiting for charging. The vehicle management server 10 determines the charging station 30, for which the robotaxi 2 is headed, based on the crowdedness information and location information of each of the charging stations 30A, 30B, 30C, 30D.

In the example shown in FIG. 2, there is no electrified vehicle that is using the charging station 30A. Therefore, even when the robotaxi 2 is allowed to enter the charging station 30A, there is a high likelihood that no potential participant who helps do work for charging the robotaxi 2 is found. In contrast, for the charging stations 30B, 30C, 30D, there are electrified vehicles being charged, so at least the drivers of the electrified vehicles are potential participants. In other words, if the robotaxi 2 enters any one of the charging stations 30B, 30C, 30D, there is a likelihood that someone there helps charge the robotaxi 2.

Subsequently, when the charging stations 30B, 30C, 30D are compared with one another, the number of electrified vehicles being charged at each of the charging stations 30C, 30D is greater than the number of electrified vehicles being charged at the charging station 30B. This means that the number of potential participants at each of the charging stations 30C, 30D is greater than the number of potential participants at the charging station 30B. Therefore, by driving the robotaxi 2 to any one of the charging stations 30C, 30D, there is a further high likelihood that someone helps charge the robotaxi 2.

The number of electrified vehicles being charged is the same between the charging station 30C and the charging station 30D, so the number of potential participants is also the same. The usage rate of the chargers is also the same, so waiting time until completion of charging is also stochastically the same. However, the charging station 30C is on the travel route to the destination; whereas the charging station 30D is at a location apart from the travel route. For this reason, in suppressing waste of time and waste of electric power consumption, the robotaxi 2 is desirably driven to the charging station 30C as compared to the charging station 30D. Based on the above-described determination, the vehicle management server 10 designates the charging station 30C as a destination of the robotaxi 2 that needs to be charged.

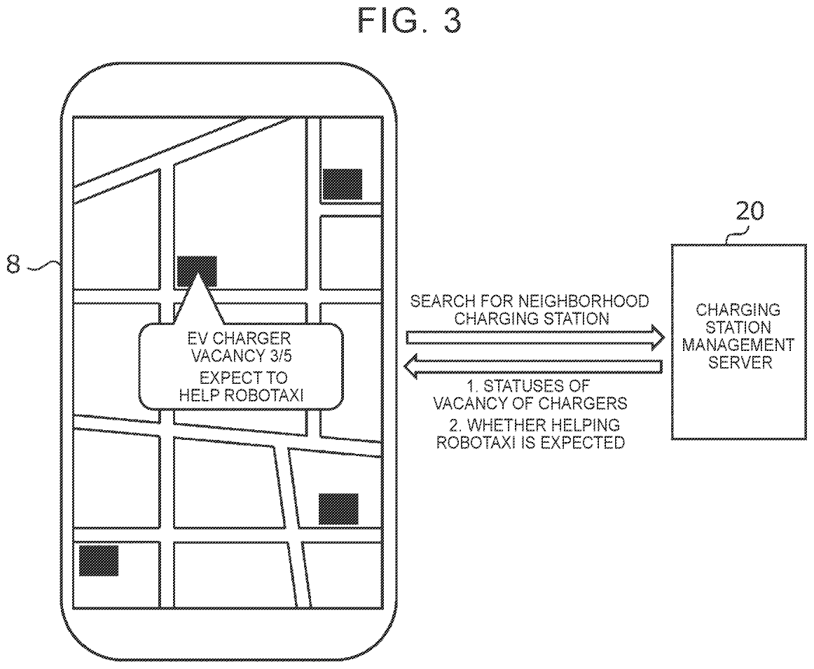

Next, a method of getting a potential participant to help the robotaxi 2 will be described. A potential participant who intends to actively help the robotaxi 2 searches with the smartphone 8 for the robotaxi 2 seeking the help. FIG. 3 shows an example of the screen of the smartphone 8. A potential participant launches the application of the smartphone 8 and searches for a neighborhood charging station. A search is made by the charging station management server 20, and the statuses of vacancy of chargers at each charging station and information on whether there are expectations for helping the robotaxi 2 are downloaded from the charging station management server 20 to the smartphone 8. The screen of the smartphone 8 shown in FIG. 3 shows that three chargers out of five charges are vacant in a nearby charging station and the robotaxi 2 seeks help. A potential participant learns which charging station to help the robotaxi 2 by viewing the display.

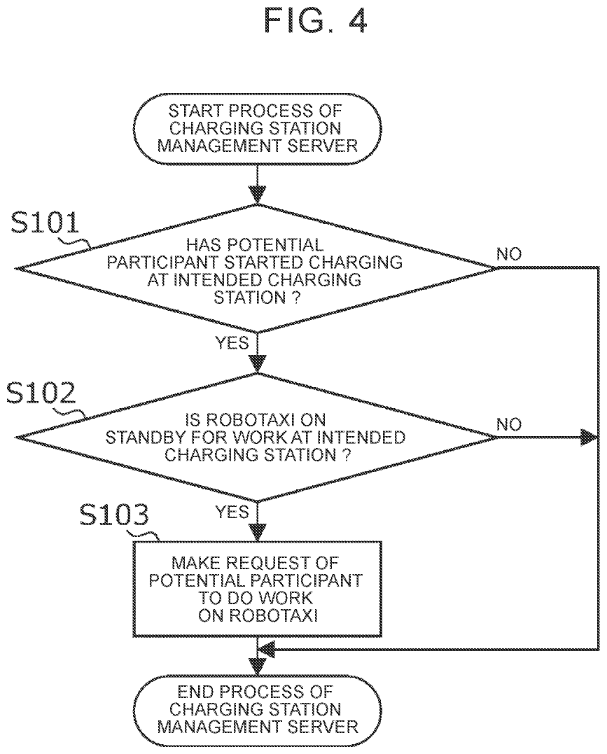

Helping the robotaxi 2 is typically achieved as follows. The charging station management server 20 makes a request of a potential participant for help, and the potential participant receives the request. When the charging station management server 20 seeks a potential participant to help the robotaxi 2, the request process shown by the flowchart in FIG. 4 is executed.

In step S101, the charging station management server 20 determines whether the potential participant starts charging at the intended charging station 30. The intended charging station 30 is a charging station designated as a destination of the robotaxi 2 by the vehicle management server 10. Here, a driver of the electrified vehicle 6 is assumed as a potential participant. When charging of the electrified vehicle 6 is started with any one of the chargers 34, the information is transmitted from the communication terminal 32 to the charging station management server 20. Until the start of charging is detected, the following processes are skipped.

When the determination result of step S101 is affirmative, the charging station management server 20 carries out determination of step S102. In step S102, the charging station management server 20 determines whether the robotaxi 2 is on standby at the intended charging station 30. Whether the robotaxi 2 is at the intended charging station is determined by acquiring the current location of the robotaxi 2, identified by the GPS, from the vehicle management server 10. The state where the robotaxi 2 is on standby means a state where the robotaxi 2 is waiting for the help to do work for charging. Work for charging includes connecting the connector to the robotaxi 2 at the start of charging and disconnecting the connector from the robotaxi 2 at the end of charging. Until the robotaxi 2 on standby appears, the following processes are skipped.

When the determination result of step S102 is affirmative, the charging station management server 20 executes the process of step S103. In step S103, the charging station management server 20 makes a request of the potential participant designated in step S101 to do work for charging the robotaxi 2. A request of the potential participant from the charging station management server 20 is made via the smartphone 8 serving as an HMI.

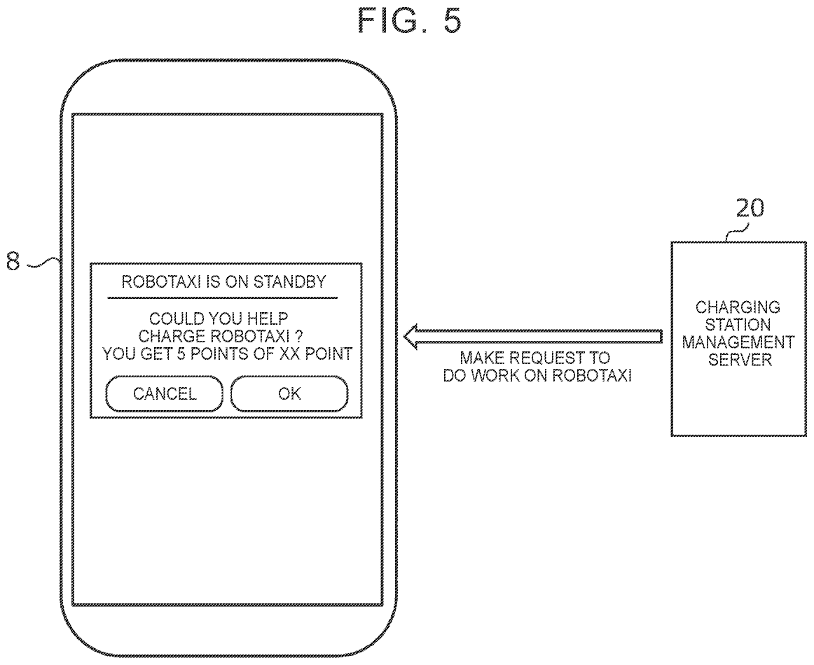

FIG. 5 is a diagram that shows an example of the screen of the smartphone 8 used to make a request of a potential participant to help charge the robotaxi 2. When the application is installed in the smartphone 8, a pop-up appears upon receiving a request from the charging station management server 20 is delivered. The pop-up describes a request to help charge the robotaxi 2. In addition, the pop-up shown in FIG. 5 describes that points are given as an incentive to help the robotaxi 2. Giving an incentive increases the likelihood that someone helps do work for charging. Giving points as an incentive is performed by the application. Points can be reserved and are allowed to be exchanged with a service or commercial product according to the reserved points.

As described above, with the management system 100 according to the present embodiment, the robotaxi 2 without a driver is operated without battery running out with the help of a person around the charging station 30 to charge the robotaxi 2.

An HMI for making a request of a surrounding person to help the robotaxi 2 is not limited to a mobile terminal, such as the smartphone 8. For example, a request of a person in a vehicle may be made by using a vehicle mount terminal mounted on an electrified vehicle. Alternatively, a request of an unspecified number of persons outside a vehicle may be made by using an external HMI, for example, a display panel and a speaker, attached to the outer surface of the robotaxi 2. A request of a potential participant may be directly made from the robotaxi 2 to help charge the robotaxi 2. Methods of making a request in this case include making a request through proximity wireless communication from the robotaxi 2 to the smartphone 8 and making a request by using an external HMI.

When a certain period of time has elapsed from the arrival of the robotaxi 2 at the charging station 30, a staff may go to the site. Thus, it is possible to avoid a situation in which the robotaxi 2 is not charged.

What is claimed is:

1. A system comprising:
one or more processors; and
a memory coupled to the one or more processors and storing a plurality of instructions that are executable, wherein
the plurality of instructions is configured to cause the one or more processors to, if an unmanned autonomous vehicle that runs on electric power needs to be charged, make a request of a person around a charging station to do work for charging the unmanned autonomous vehicle with an HMI.

2. The system according to claim 1, wherein making a request to do work for charging the unmanned autonomous vehicle includes making a request of a user using the charging station to do work for charging the unmanned autonomous vehicle.

3. The system according to claim 1, wherein the plurality of instructions is configured to cause the one or more processors to make a request to do work for charging the unmanned autonomous vehicle in response to detection that the unmanned autonomous vehicle is on standby at the charging station.

4. The system according to claim 1, wherein the plurality of instructions is configured to cause the one or more processors to, if the unmanned autonomous vehicle needs to be charged, head the unmanned autonomous vehicle for a charging station being used by a user.

5. The system according to claim 1, wherein the HMI is a mobile terminal that a person around the charging station carries.

6. The system according to claim 1, wherein the HMI is a vehicle mount terminal of a vehicle in which a person around the charging station is riding.

7. The system according to claim 1, wherein making a request to do work for charging the unmanned autonomous vehicle includes making a request to do work for charging the unmanned autonomous vehicle in return for giving an incentive.

8. A method for managing, with a computer, an unmanned autonomous vehicle that runs on electric power, the method comprising
if the unmanned autonomous vehicle needs to be charged, making a request of a person around a charging station to do work for charging the unmanned autonomous vehicle with an HMI.

9. A non-transitory storage medium storing a program configured to cause a computer to execute functions, the functions comprising, if an unmanned autonomous vehicle that runs on electric power needs to be charged, making a request of a person around a charging station to do work for charging the unmanned autonomous vehicle with an HMI.
